(19) United States
(12) Patent Application Publication
(10) Pub. No.: US 2009/0070014 A1
(43) Pub. Date: Mar. 12, 2009

(54) CONTROL SYSTEM FOR INTERNAL COMBUSTION ENGINE

(75) Inventor: Shigeki Miyashita, Shizuoka-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, TOYOTA-SHI (JP)

(21) Appl. No.: 11/914,706

(22) PCT Filed: May 12, 2006
(86) PCT No.: PCT/JP2006/309978

§ 371 Date: Nov. 16, 2007

(30) Foreign Application Priority Data
May 17, 2005 (JP) 2005-143959

(51) Int. Cl. F02D 41/30

(52) U.S. Cl. 701/105

(57) ABSTRACT

An object of the present invention is to provide a technique that enables to more preferably suppress an unpreferable exhaust emission in an internal combustion engine having a supercharger while the supercharging pressure is increased by the supercharger. According to the present invention, in an internal combustion engine having a supercharger and an exhaust gas purification catalyst provided in the exhaust passage, while the supercharging pressure is increased by the supercharger, the quantity of the flow-through air that flows from the intake port out into the exhaust port during the valve overlap period is regulated by controlling the valve overlap period (S110, S112) so that the air fuel ratio of the exhaust gas becomes a target air fuel ratio.

### TECHNICAL FIELD

The present invention relates to a control system for an internal combustion engine, and in particular to a control system for an internal combustion engine equipped with a supercharger that supercharges the intake air utilizing the energy of the exhaust gas.

### PRIOR ART

According to a technique disclosed in Japanese Patent Application Laid-Open No. 2002-266686, in an internal combustion engine having a supercharger for supercharging the intake air utilizing the energy of the exhaust gas, the longer the valve overlap period defined as the period during which both the intake valve and the exhaust valve are open is, and the higher the supercharging pressure is, the more the fuel injection timing is retarded.

According to a technique disclosed in Japanese Patent Application Laid-Open No. 5-1581, in an internal combustion engine having a supercharger and a fuel injection valve disposed in an intake port, while supercharging by the supercharger is performed, fuel injection is effected during the valve overlap period, and while supercharging by the supercharger is not performed, fuel injection start timing is advanced as compared to when supercharging is performed. Japanese Patent Application Laid-Open No. 7-151006, Japanese Patent No. 3323542, Japanese Patent Application Laid-Open No. 2000-73800 and Japanese Patent Application Laid-open No. 2000-192820 also disclose techniques concerning control of valve timing and the fuel injection timing.

### DISCLOSURE OF THE INVENTION

An object of the present invention is to provide a technique that enables to more preferably suppress the unpreferable exhaust emission in an internal combustion engine having a supercharger while the supercharging pressure is increased by the supercharger.

According to the present invention, while the supercharging pressure is increased by the supercharger, the quantity of the flow-through air that flows from the intake port to the exhaust port during the valve overlap period is regulated by controlling the valve overlap period so that the air fuel ratio of the exhaust gas becomes a target air fuel ratio.

More specifically, a control system for an internal combustion engine according to the present invention comprises:

a supercharger that supercharges intake air using the energy of the exhaust gas;

an exhaust gas purification catalyst for purifying the exhaust gas provided in an exhaust passage;

overlap control means for controlling a valve overlap period defined as a period during which both an intake valve and an exhaust valve are open,

wherein while the supercharging pressure is increased by said supercharger, said valve overlap period is controlled by said valve overlap control means to regulate the quantity of flow-through air that flows from an intake port out into an exhaust port during the valve overlap period, whereby the air fuel ratio of the exhaust gas is adjusted to a target air fuel ratio.

While the supercharging pressure is increased by the supercharger, the pressure in the intake passage is higher than the pressure in the exhaust passage, namely, the pressure in the intake port is higher than the pressure in the exhaust port. Therefore, during the valve overlap period, at least a part of the air flowing from the intake port out into the cylinder will flow out into the exhaust port without being used in combustion in the cylinder. The air thus flowing from the intake port out into the exhaust port during the valve overlap period will be referred to as the flow-through air.

In the present invention, the valve overlap period is controlled by the valve overlap control means so as to adjust the air fuel ratio of the exhaust gas to a target air fuel ratio. Here, the target air fuel ratio is set as a value at which it is possible to suppress the unpreferable exhaust emission. The value of the target air fuel ratio may be determined in accordance with characteristics of the exhaust gas purification catalyst provided in the exhaust passage. The value of the air fuel ratio may be varied depending on running conditions of the internal combustion engine.

When the timing of closing the exhaust valve is retarded or when the timing of opening the intake valve is advanced, the length of the valve overlap period becomes longer. On the other hand, when the timing of closing the exhaust valve is advanced or when the timing of opening the intake valve is retarded, the length of the valve overlap period becomes shorter.

The longer the length of the valve overlap period is, the larger the quantity of the flow-through air is. The shorter the length of the valve overlap period is, the smaller the quantity of the flow-through air is. Thus, it is possible to adjust the flow-through air quantity by controlling the overlap period, to thereby control the air fuel ratio of the exhaust gas.

The air fuel ratio of the exhaust gas can also be adjusted by controlling the fuel injection quantity in the internal combustion engine. However, a change in the flow-through air quantity has less influence on the air fuel ratio of the air-fuel mixture used in combustion in the cylinder than a change in the fuel injection quantity. Accordingly, when the air fuel ratio of the exhaust gas is controlled by adjusting the flow-through air quantity, it is possible to adjust the air fuel ratio of the exhaust gas to a target air fuel ratio while suppressing influence on running conditions of the internal combustion engine.

Therefore, according to the present invention, by adjusting the air fuel ratio of the exhaust gas to a target air fuel ratio by controlling the flow-through air quantity while the supercharging pressure is increased by the supercharger, it is possible to suppress the unpreferable exhaust emission more preferably.

In the present invention, in the case where the exhaust gas purification catalyst used is a three way catalyst, the aforementioned target air fuel ratio may be set to the theoretical air fuel ratio or a value close to the theoretical air fuel ratio.

The three way catalyst can purify the exhaust gas more effectively when the air fuel ratio of the ambient atmosphere is equal to or close to the theoretical air fuel ratio. Therefore, in the case where the exhaust gas purification catalyst is a three way catalyst, it is possible to suppress the unpreferableexhaust emission more preferably by controlling the air fuel ratio of the exhaust gas in the above described manner.

In the present invention, the aforementioned target air fuel ratio may be set to a lean air fuel ratio or a slightly rich air fuel ratio.

Here, the slightly rich air fuel ratio means an air fuel ratio slightly that is lower than the theoretical air fuel ratio and at which the possibility that the quantity of the unburned fuel component in the exhaust gas becomes so large as to cause an excessive temperature rise of the exhaust gas purification catalyst is low.

When the air fuel ratio of the exhaust gas is adjusted to a lean air fuel ratio or a slightly rich air fuel ratio by regulating the flow-through air quantity, the quantity of the unburned fuel component contained in the exhaust gas or the quantity of the unburned fuel component supplied to the exhaust gas purification catalyst is made small. Consequently, it is possible to prevent excessive temperature rise of the exhaust gas purification catalyst. Thus, it is possible to prevent deterioration in the exhaust gas purification performance of the exhaust gas purification catalyst associated with an excessive temperature rise of the exhaust gas purification catalyst. Therefore, the above described process also makes it possible to suppress an increase in harmful exhaust emission more preferably.

The system according to the present invention may be further provided with a fuel injection valve for injecting fuel into the intake port or the cylinder and fuel injection timing control means for controlling the timing at which fuel is injected through the fuel injection valve and a fuel injection quantity control means for controlling the quantity of fuel injection through the fuel injection valve. In this case, while the supercharging pressure is increased by the supercharger, the timing at which fuel is injected through the fuel injection valve is controlled to be timing in which at least a part of the injected fuel flows out into the exhaust port with the flowing-through air.

For example, in the case where the fuel injection valve is adapted to inject fuel into the intake port, it is possible to cause at least a part of the injected fuel to flow out into the exhaust port together with the flow-through air by injecting fuel through the fuel injection valve during the exhaust stroke or during the valve overlap period while the supercharging pressure is increased by the supercharger. On the other hand, in the case where the fuel injection valve is adapted to inject fuel into the cylinder, it is possible to cause at least a part of the injected fuel to flow out into the exhaust port together with the flow-through air by injecting fuel through the fuel injection valve during the valve overlap period while the supercharging pressure is increased by the supercharger.

When fuel flows out into the exhaust port with the flow-through air while the supercharging pressure is increased by the supercharger, the fuel that has flowed out is burned in the exhaust passage. Consequently, the temperature of the exhaust gas can be raised. This means that the energy of the exhaust gas can be increased.

In the above process, the lower the air fuel ratio of the air-fuel mixture composed of the flow-through air and the fuel that has flown out into the exhaust port with the flow-through air (which air-fuel mixture will be hereinafter referred to as the flow-through air-fuel mixture) is, the larger the energy generated in the fuel combustion is. However, since the specific heat of fuel is larger than the specific heat of air, the lower the air fuel ratio of the flow-through air-fuel mixture is, the higher the specific heat of the flow-through air-fuel mixture is. Accordingly, if the air fuel ratio of the flow-through air fuel mixture is excessively low, the temperature of the exhaust gas is hard to rise even when the fuel is burned. Therefore, the increase in the temperature of exhaust gas upon combustion of the fuel in the flow-through air-fuel mixture becomes maximum in the case where the air fuel ratio of the flow-through air-fuel mixture is equal to the theoretical air fuel ratio, and the energy of the exhaust gas also becomes maximum in that case accordingly.

Therefore, in the system according to the present invention, when fuel is caused to flow out into the exhaust port with the flow-through air, the air fuel ratio of the flow-through air-fuel mixture may be adjusted to the theoretical air fuel ratio or an air fuel ratio close to the theoretical air fuel ratio by controlling the timing of fuel injection through the fuel injection valve and controlling the fuel injection quantity.

In this way, it is possible to increase the energy of the exhaust gas while the supercharging pressure is increased by the supercharger. As a result, it is possible to increase the supercharging pressure more rapidly.

Also in the case where, as described above, fuel is caused to flow out into the exhaust port together with the flow-through air and the flow-through air-fuel mixture is to be adjusted to a certain value such as the theoretical air fuel ratio, an air fuel ratio close to the theoretical air fuel ratio, a lean air fuel ratio or a slightly rich air fuel ratio, while the supercharging pressure is increased by the supercharger, it is possible to regulate the quantity of the flow-through air by controlling the valve overlap period thereby adjusting the air fuel ratio of the exhaust gas to the theoretical air fuel ratio or an air fuel ratio close to the theoretical air fuel ratio.

As per the above, while the supercharging pressure is increased by the supercharger, it is possible to increase the supercharging pressure more rapidly while suppressing the unpreferable exhaust emission more preferably by adjusting not only the air fuel ratio of the exhaust gas but also the air fuel ratio of the flow-through air-fuel mixture to the theoretical air fuel ratio or an air fuel ratio close to the theoretical air fuel ratio.

The system according to the present invention may be controlled in such way that when the supercharging pressure is increased by the supercharger, at least a part of fuel injected through the fuel injection valve is caused to flow out into the exhaust port together with the flow-through air only until the supercharging pressure reaches a specified supercharging pressure that is lower than a required supercharging pressure that is demanded, and after the supercharging pressure has reached the specified supercharging pressure, flowing of the fuel injected through the fuel injection valve out into the exhaust passage together with the flow-through air may be prohibited

As described above, when fuel is caused to flow out into the exhaust port together with the flow-through air while the supercharging pressure is increased by the supercharger, the supercharging pressure can be increased more rapidly. However, even in the case where the supercharging pressure is to be increased to a required supercharging pressure, if the supercharging pressure increases to some extent, the supercharging pressure will rise to the required pressure rapidly even when the energy of the exhaust gas is not increased by burning fuel in the exhaust passage.

In view of this, when the supercharging pressure is increased by the supercharger, the timing of fuel injection through the fuel injection valve is controlled in such a way that fuel is caused to flow out into the exhaust port together with the flow-through air only until the supercharging pressure reaches a specified supercharging pressure that is lower than a required supercharging pressure. After that time, flowing of fuel out into the exhaust port together with the flow-through air is prohibited. In other words, the timing of fuel injection through the fuel injection valve is controlled in such a way that fuel does not flow out into the exhaust port with the flow-through air.

Here, the aforementioned specified supercharging pressure is a value that is set in such a way that when the supercharging pressure rises to the specified supercharging pressure, it can be considered that the supercharging pressure will rise rapidly to the required supercharging pressure even if fuel is not burned in the exhaust passage. The value of the specified supercharging pressure is determined depending on the required supercharging pressure.

According to the present invention as per the above, it is possible to reduce the quantity of fuel used for increasing the energy of the exhaust gas. Therefore, it is possible to increase the supercharging pressure more rapidly while suppressing deterioration in fuel consumption.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a diagram schematically showing an internal combustion engine according to a first embodiment of the present invention and its air-intake and exhaust systems.

FIG. 2 is a graph showing timing of opening/closing an intake valve and an exhaust valve and a fuel injection timing through a fuel injection valve according to the first embodiment of the present invention.

FIG. 3 is a flow chart of a control routine for controlling a valve overlap period according to the first embodiment of the present invention.

FIG. 4 is a graph showing timing of opening/closing an intake valve and an exhaust valve and a fuel injection timing through a fuel injection valve according to a second embodiment of the present invention.

FIG. 5 is a flow chart of a control routine for controlling a valve overlap period according to the second embodiment of the present invention.

FIG. 6 is a flow chart of a control routine for controlling the fuel injection timing while the supercharging pressure is increased according to a third embodiment of the present invention.

### DESCRIPTION OF-THE PREFERRED EMBODIMENT

In the following, specific embodiments of the control system for an internal combustion engine according to the present invention will be described with reference to the accompanying drawings.

### First Embodiment

### Basic Structure of Internal Combustion Engine and its Air-Intake and Exhaust Systems

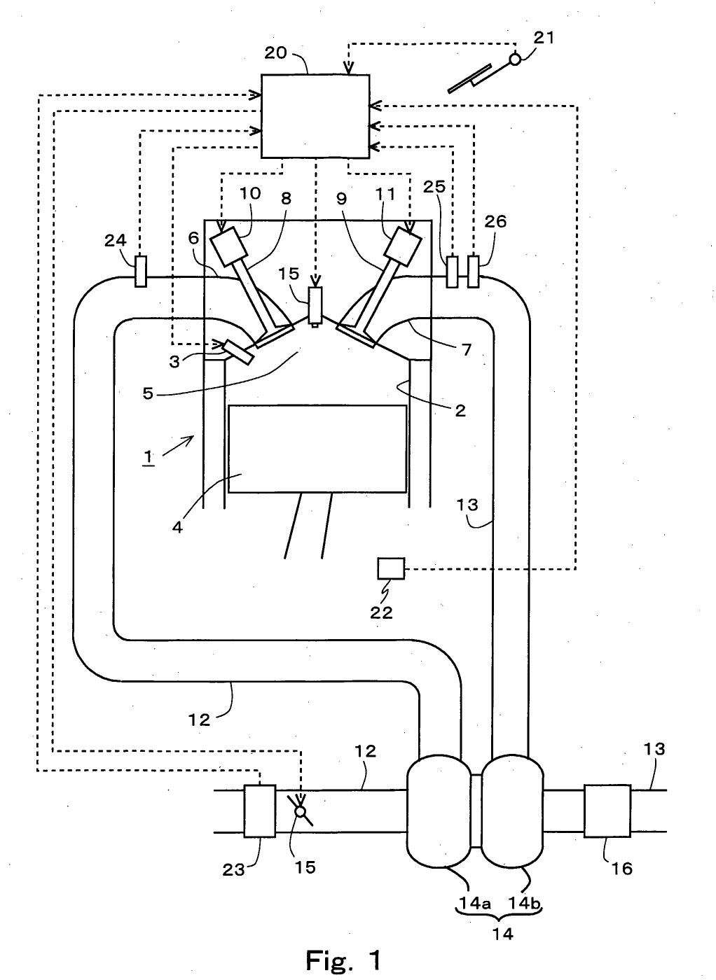

In the embodiment described in the following, the present invention is applied to a gasoline engine for driving a vehicle. FIG. 1 is a diagram schematically showing an internal combustion engine according to this embodiment and its air-intake and exhaust systems. The internal combustion engine 1 has a cylinder, in which a piston 4 is slidably provided. A combustion chamber 5 formed in the upper part of the cylinder 2 is connected with an intake port 6 and an exhaust port 7.

The openings of the intake port 6 and the exhaust port 7 to the combustion chamber 5 are opened/closed by an intake valve 8 and an exhaust valve 9 respectively. An intake variable valve drive mechanism 10 and an exhaust variable valve drive mechanism 11 are provided respectively for the intake valve 8 and the exhaust valve 9, so that the open/close timing of the respective valves can be varied. In the cylinder 2, there is provided a fuel injection valve 3 for injecting fuel into the combustion chamber 5 and an ignition plug 15 for igniting the air-fuel mixture in the combustion chamber 5.

The intake port 6 and the exhaust port 7 are connected with an intake passage 12 and an exhaust passage 13 respectively. At a certain position in the intake passage 12 is provided a compressor 14a of a turbocharger (supercharger) 14. On the other hand, at a certain position in the exhaust passage 13 is provided a turbine 14b of the turbocharger 14.

An air flow meter 23 that outputs an electric signal indicative of the flow rate of the intake air and a throttle valve 15 for regulating the flow rate of intake air are provided in the intake passage 12 upstream of the compressor 14a. An intake air pressure sensor 24 that outputs an electric signal indicative of the pressure in the intake passage 12 is provided in the intake passage 12 downstream of the compressor 14a.

On the other hand, an exhaust gas pressure sensor 25 that outputs an electric signal indicative of the pressure in the exhaust gas passage 13 and an air fuel ratio sensor 26 that outputs an electric signal indicative of the air fuel ratio of the exhaust gas are provided in the exhaust passage 13 upstream of the turbine 14b. A three way catalyst 16 is provided in the exhaust passage 13 downstream of the turbine 14b.

To the internal combustion engine 1 having the above-described structure is annexed an ECU 20 that controls the internal combustion engine 1. The ECU 20 is a unit that controls running conditions of the internal combustion engine 1 in accordance with running requirements of the internal combustion engine 1 and driver's demands. The ECU 20 is electrically connected with various sensors such as the air flow meter 23, the intake air pressure sensor 24, the exhaust gas pressure sensor 25, the air fuel ratio sensor 26, an accelerator position sensor 21 and a crank position sensor 22. The accelerator position sensor 21 is adapted to output an electric signal indicative of the accelerator pedal position of the vehicle on which the internal combustion engine 1 is mounted. The crank position sensor 22 is adapted to output an electric signal indicative of the rotational angle of the crankshaft that turns interlocked with reciprocating movement of the piston 4. The output signals of these sensors are input to the ECU 20.

The ECU 20 is electrically connected also with the throttle valve 15, the fuel injection valve 3, the ignition plug 15, the intake variable valve drive mechanism 10 and the exhaust variable valve drive mechanism 11. These components are controlled by the ECU 20. For example, the ECU 20 controls the intake variable valve drive mechanism 10 and the exhaust variable valve drive mechanism 11 to control the open/close timing of the intake valve 8 and the exhaust valve 9 respectively. Thus, the valve overlap period during which both the intake valve 8 and the exhaust valve 9 are open is controlled.

### Timing of Opening/Closing Intake and Exhaust Valves and Fuel Injection Timing

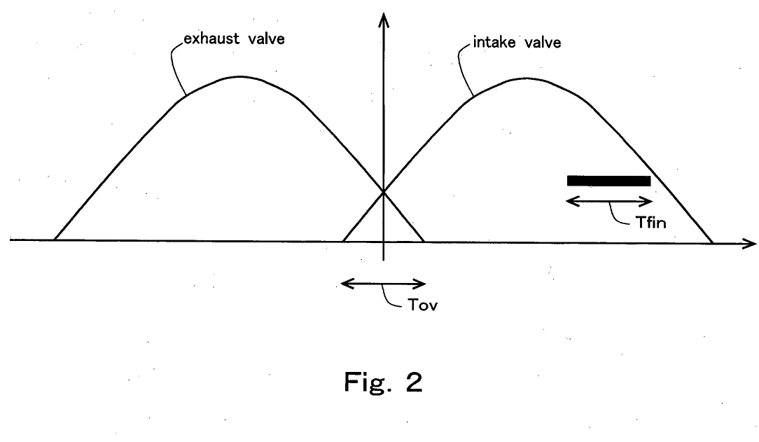

Here, the timing of opening/closing the intake valve 8 and the exhaust valve 9 and the timing of fuel injection through the fuel injection valve 3 according to this embodiment will be described with reference to FIG. 2. FIG. 2 shows the timing of opening/closing the intake valve 8 and the exhaust valve 9 and the timing of fuel injection through the fuel injection valve 3 in this embodiment. In FIG. 2, the horizontal axis represents time and the vertical axis represents the degree of opening of the intake valve 8 and the exhaust valve 9.

As shown in FIG. 2, in this embodiment, the intake valve 8 is opened before the exhaust valve 9 is closed. Thus, the period indicated as Tov in FIG. 2 constitutes a valve overlap period. (This period will be referred to as the valve overlap period Tov hereinafter.) While the supercharging pressure is increased by the turbocharger 14 as is the case during acceleration, the pressure in the intake passage 12 is higher than the pressure in the exhaust passage 13. Accordingly, in the valve overlap period Tov, there is flow-through air that flows from the intake port 6 out into the exhaust port 7 without being used in the combustion in the cylinder 2.

In FIG. 2, Tfin represents the fuel injection timing at which fuel is injected through the fuel injection valve 15. (This period will be referred to as the fuel injection timing Tfin hereinafter.) As will be seen from FIG. 2, the fuel injection timing Tfin in this embodiment is set as a period after the valve overlap period has ended. Hence the fuel injected during the fuel injection timing Tfin will not flow out into the exhaust port 7 with the flow-through air during the valve overlap period Tov.

### Control of Valve Overlap Period While Supercharging Pressure is Increased

In the following, how in this embodiment the valve overlap period Tov is controlled while the supercharging pressure is increased by the turbocharger 14 will be discussed.

As described above, while the supercharging pressure is increased, flow-through of air occurs during the valve overlap period Tov. The longer the valve overlap period Tov is, the larger the length of the quantity of the flow-through air is, while the shorter the length of the valve overlap period is, the smaller the quantity of the flow-through air is. This means that the quantity of the flow-through air can be regulated by controlling the valve overlap period Tov.

In this embodiment, while the supercharging pressure is increased, the quantity of the flow-through air is controlled to adjust the air fuel ratio of the exhaust gas to a value close to the theoretical air fuel ratio. In this embodiment, the three way catalyst 16 is provided in the exhaust passage 13. Thus, it is possible to purify the exhaust gas with this three way catalyst 16 more effectively when the air fuel ratio of the exhaust gas is adjusted to a value close to the theoretical air fuel ratio.

### Control Routine for Controlling Valve Overlap Period

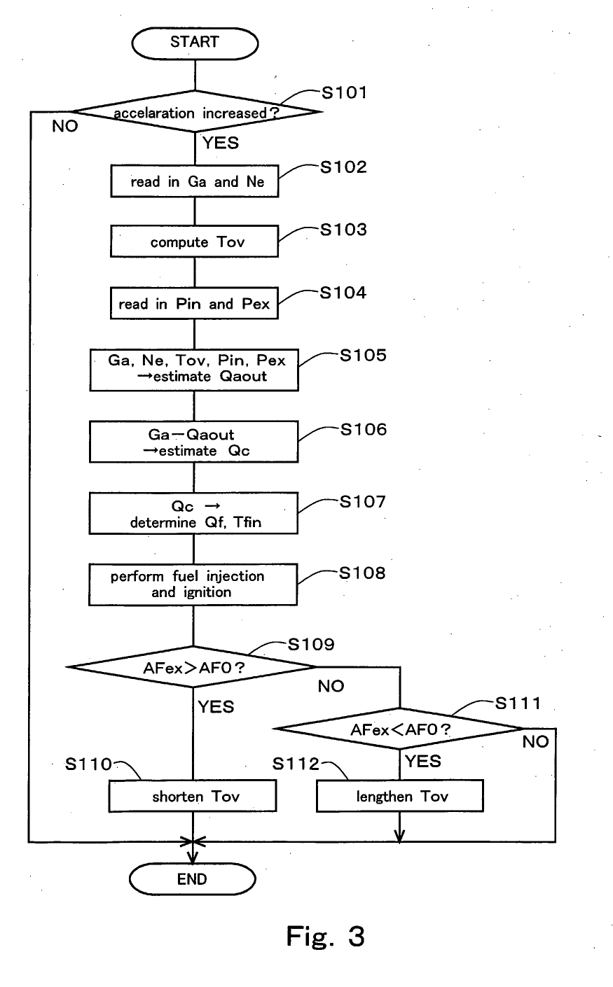

In the following, a control routine for controlling the valve overlap period according to this embodiment will be described with reference to the flow chart of FIG. 3. This routine is stored in the ECU 20 in advance, and executed repeatedly at regular intervals while the internal combustion engine 1 is running.

In this routine, firstly in step S101, a determination is made by the ECU 20 as to whether or not the accelerator position has been changed in the direction for increasing the acceleration based on the detection value of the accelerator position sensor 21. If the question in step S101 is answered in the affirmative, it is considered that the supercharging pressure is increased by the turbocharger 14, and the process of the ECU 20 proceeds to step S102. On the other hand, if the question in step S101 is answered in the negative, it is considered that the supercharging pressure is not increased, and the ECU 20 once terminates execution of this routine.

In step S102, the ECU 20 reads in the intake air quantity Ga detected by the air flow meter 23 and the number of revolutions (or the engine speed) Ne of the internal combustion engine 1 that is computed based on the value detected by the crank position sensor 22.

Then, the process of the ECU 20 proceeds to step S103, where the ECU 20 computes the length of the valve overlap period Tov with reference to the time at which the exhaust valve 9 is closed and the time at which the intake valve 8 is opened.

Then, the process of the ECU 20 proceeds to step S104, where the ECU 20 reads in the pressure Pin in the intake passage 12 (which pressure will be hereinafter referred to as the intake pressure Pin) detected by the intake air pressure sensor 24 and the pressure Pex in the exhaust passage 13 (which pressure, will be hereinafter referred to as the exhaust pressure Pex) detected by the exhaust gas pressure sensor 25.

Then, the process of the ECU 20 proceeds to step S105, where the ECU 20 estimates the flow-through air quantity Qaout based on the intake air quantity Ga, the number of revolutions of the engine Ne, the length of the valve overlap period Tov, the intake pressure Pin and the exhaust pressure Pex. The larger the intake air quantity Ga is, and the larger the number of revolutions of the engine Ne is, the larger the flow-through air quantity Qaout is. Furthermore, the longer the length of the valve overlap period Tov becomes, the larger the flow-through air quantity Qaout becomes, as described before. Still further, The larger the difference between the intake pressure Pin and the exhaust pressure Pex is, the larger the flow-through air quantity Qaout becomes. The relationship between the intake air quantity Qaout and the other variables such as the intake air quantity Ga, the number of revolutions of the engine Ne, the length of the valve overlap period Tov, the intake pressure Pin and the exhaust pressure Pex is determined for example by experiments, and stored in the ECU 20 in advance.

Then, the process of the ECU 20 proceeds to step S106, where the ECU 20 estimates the in-cylinder air quantity Qc that is used in combustion in the cylinder 2 by subtracting the flow-through air quantity Qaout from the intake air quantity Ga.

Then, the process of the ECU 20 proceeds to step S107, where the ECU 20 determines the fuel injection quantity Qf and the fuel injection timing Tfin with which the required engine power can be achieved, based on the in-cylinder air quantity Qc estimated as above. The fuel injection timing Tfin is determined as a certain timing appearing after the valve overlap period has ended.

Then, the process of the ECU 20 proceeds to step S108, where the ECU 20 controls to perform fuel injection by the fuel injection valve 3 and ignition by the ignition plug 15.

Then, the process of the ECU 20 proceeds to step S109, where a determination is made as to whether or not the air fuel ratio AFex of the exhaust gas detected by the air fuel ratio sensor 26 is higher than the theoretical air fuel ratio AF0. If the question in step S109 is answered in the affirmative, the process of the ECU 20 proceeds to step. S110, and if answered in the negative, the process of the ECU 20 proceeds to step S111.

In step S110, the ECU 20 shortens the valve overlap period Tov by controlling the exhaust variable valve drive mechanism 11 and/or the intake variable valve drive mechanism 10 to adjust the air fuel ratio AFex of the exhaust gas to the theoretical air fuel ratio AF0. In other words, the ECU 20 controls to decrease the flow-through air quantity Qaout. In connection with this, the valve overlap period Tov may be shortened by advancing the timing of closing the exhaust valve 9 or by retarding the timing of opening the intake valve 8. After shortening the valve overlap period Tov, the ECU 20 once terminates execution of this routine.

In step S111, a determination is made by the ECU 20 as to whether or not the air fuel ratio AFex of the exhaust gas is lower than the theoretical air fuel ratio AF0. If the question in step S111 is answered in the affirmative, the process of the ECU 20 proceeds to step S112. On the other hand, if the question in step S111 is answered in the negative, it is considered that the air fuel ratio AFex of the exhaust gas is equal to the theoretical air fuel ratio AF0, and the ECU 20 once terminates execution of this routine.

In step S112, the ECU 20 lengthens the valve overlap period Tov by controlling the exhaust variable valve drive mechanism 11 and/or the intake variable valve drive mechanism 10 to adjust the air fuel ratio AFex of the exhaust gas to the theoretical air fuel ratio AF0. In other words, the ECU 20 controls to increase the flow-through air quantity Qaout. In connection with this, the valve overlap period Tov may be lengthened by retarding the timing of closing the exhaust valve 9 or by advancing the timing of opening the intake valve 8. After lengthening the valve overlap period Tov, the ECU 20 once terminates execution of this routine.

According to the above described control routine, it is possible to adjust the air fuel ratio AFex of the exhaust gas to the theoretical air fuel ratio AF0 by controlling the flow-through air quantity Qaout while the supercharging pressure is increased. Consequently, the exhaust gas is purified in the three way catalyst 16 more effectively.

The air fuel ratio AFex of the exhaust gas can also be adjusted by controlling the fuel injection quantity Qf through the fuel injection valve 3. However, a change in the flow-through air quantity Qaout has less influence on the air fuel ratio of the air-fuel mixture used in combustion in the cylinder 2 than a change in the fuel injection quantity Qf. Accordingly, when the air fuel ratio AFex of the exhaust gas is adjusted by controlling the flow-through air quantity Qaout, it is possible to adjust the air fuel ratio AFex of the exhaust gas to the theoretical air fuel ratio AF0 while suppressing influence on running conditions of the internal combustion engine 1.

Therefore, according to this embodiment, it is possible to suppress the unpreferable exhaust emission more preferably while the supercharging pressure is increased by the turbocharger 14.

The description of this embodiment has been directed to a case where the air fuel ratio of the exhaust gas is adjusted to the theoretical air fuel ratio by controlling the quantity of the flow-through air while the supercharging pressure is increased. However, the air fuel ratio of the exhaust gas may be adjusted to a lean air fuel ratio or a slightly rich air fuel ratio, alternatively.

Here, the slightly rich air fuel ratio refers to such an air fuel ratio that is slightly lower than the theoretical air fuel ratio and at which the possibility that the quantity of the unburned fuel component in the exhaust gas becomes so large as to invite an excessive temperature rise of the three way catalyst 16 is low. When the air fuel ratio of the exhaust gas is to be adjusted to a lean air fuel ratio or a slightly rich air fuel ratio, the value of the target air fuel ratio is determined in accordance with running conditions of the internal combustion engine 1. The relationship between the value of the target air fuel ratio and running conditions of the internal combustion engine 1 may be determined in advance by, for example, experiments.

By adjusting the air fuel ratio of the exhaust gas to a lean air fuel ratio or a slightly rich air fuel ratio by controlling the quantity of the flow-through air, the quantity of the unburned fuel component in the exhaust gas or the quantity of the unburned fuel component supplied to the three way catalyst 16 can be reduced. Consequently, it is possible to prevent an excessive temperature rise of the three way catalyst 16, whereby it is possible to reduce deterioration in the exhaust gas purifying performance of the three way catalyst 16 caused by an excessive temperature rise of the three way catalyst 16. As per the above, according to this control method also, it is possible to suppress the unpreferable exhaust emission more preferably.

The method of adjusting the air fuel ratio of the exhaust gas to a lean air fuel ratio or a slightly rich air fuel ratio may be applied not only to the case where the exhaust gas purification catalyst provided in the exhaust passage 13 is a three way catalyst but also to the case where the exhaust gas purification catalyst is a different type of catalyst such as an oxidation catalyst, an NOx storage reduction catalyst or an NOx selective reduction catalyst.

### Second Embodiment

The basic structure of the internal combustion engine according to this second embodiment and its air-intake and exhaust systems is the same as that shown in FIG. 1, and a description thereof will be omitted.

### Timing of Opening/Closing Intake and Exhaust Valves and Fuel Injection Timing

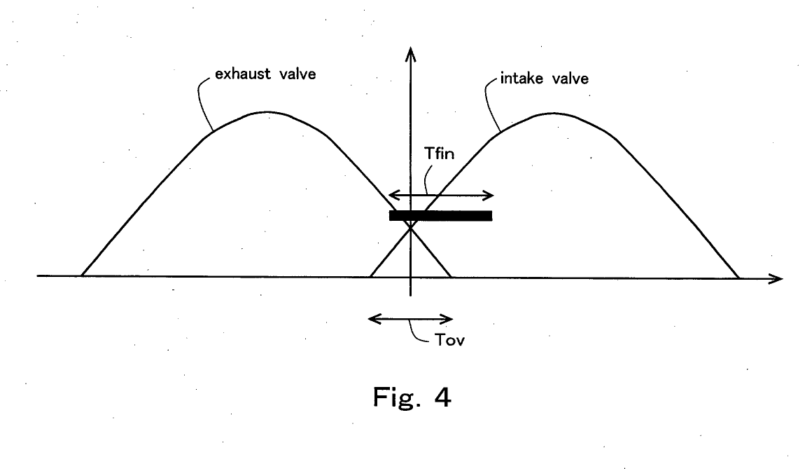

Here, the timing of opening/closing the intake valve 8 and the exhaust valve 9 and the timing of fuel injection through the fuel injection valve 3 according to this embodiment will be described with reference to FIG. 4. FIG. 4 shows the timing of opening/closing the intake valve 8 and the exhaust valve 9 and the timing of fuel injection through the fuel injection valve 3 in this embodiment. In FIG. 4, the horizontal axis represents time and the vertical axis represents the degree of opening of the intake valve 8 and the exhaust valve 9.

As shown in FIG. 4, the timing of opening and closing the intake valve 8 and the exhaust valve 9 is the same as that shown in FIG. 2. Namely, the intake valve 8 is opened before the exhaust valve 9 is closed. Thus, the period indicated as Tov constitutes a valve overlap period Tov. In FIG. 4 also, the fuel injection timing Tfin is represented as timing Tfin, in the same manner as in FIG. 2.

In this embodiment, the fuel injection timing Tfin partly overlaps the valve overlap period Tov, as will be seen from FIG. 4. Specifically, fuel injection through the fuel injection valve 3 is started during the valve overlap period Tov and ended after completion of the valve overlap period Tov. Accordingly, a part of the fuel injected during the fuel injection timing Tfin flows out into the exhaust port 7 together with the flow-through air during the valve overlap period Tov. The fuel that flows out into the exhaust port 7 together with the flow-through air during the valve overlap period Tov will be referred to as the flow-through fuel, hereinafter.

If the fuel injection timing Tfin is set in the above described manner to allow occurrence of fuel flow-through while the supercharging pressure is increased by the turbocharger 14 as is the case during acceleration, it is possible to increase the temperature of the exhaust gas, since the flow-through fuel is burned in the exhaust passage 13. Therefore, it is possible to increase the energy of the exhaust gas.

In this embodiment, the fuel injection quantity and the fuel injection timing Tfin while the supercharging pressure is increased are determined taking into account the quantity of the flow-through fuel.

### Control Routine for Controlling Valve Overlap Period

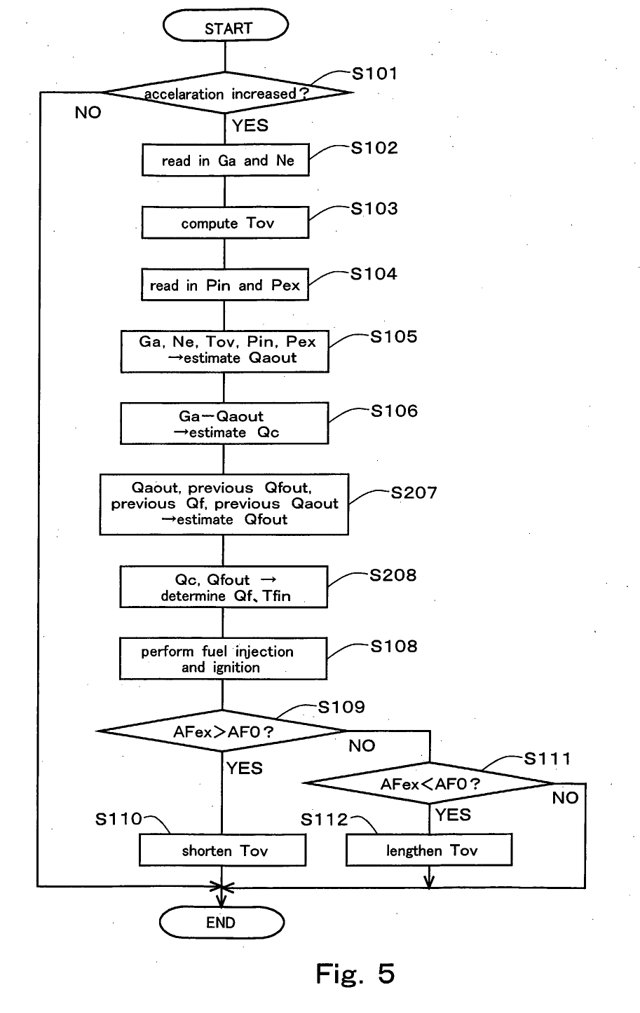

In the following, a control routine for controlling the valve overlap period according to this embodiment will be described with reference to the flow chart of FIG. 5. This routine is the same as the routine shown in FIG. 3 except that step S107 is replaced by steps S207 and S208. Therefore, only steps S207 and S208 will be described. This routine is stored in the ECU 20 in advance, and executed repeatedly at regular intervals while the internal combustion engine 1 is running, as is the case with the above described routine.

In this routine, after step S106 the process of the ECU 20 proceeds to step S207. In step S207, the ECU 20 estimates the flow-through fuel quantity Qfout in this fuel injection based on the flow-through fuel quantity Qfout, the fuel injection quantity Qf and the flow-through air quantity Qaout determined in the latest execution of this routine and the flow-through air quantity Qaout estimated in step S105.

Then, the process of the ECU 20 proceeds to step S208, where the ECU 20 determines the fuel injection quantity Qf and the fuel injection timing Tfin with which the required engine power can be achieved based on the estimated in-cylinder air quantity Qc and the estimated flow-through fuel quantity Qfout. In this step, the fuel injection quantity Qf is determined by adding the flow-through fuel quantity Qfout to the fuel injection quantity calculated based on the in-cylinder air quantity Qc. After step S208, the process of the ECU 20 proceeds to step S108.

According to this embodiment, even in the case where flow-through of fuel occurs with flow-through of air while the supercharging pressure is increased, it is possible to adjust the air fuel ratio AFex of the exhaust gas to the theoretical air fuel ratio AF0 by controlling the flow-through air quantity Qaout. Therefore, it is possible to suppress an increase in harmful exhaust emission more preferably.

### Modification

In the process of the second embodiment, the timing and the quantity of the fuel injection through the fuel injection valve 3 may be controlled to adjust not only the air fuel ratio of the exhaust gas but also the air fuel ratio of the flow-through air-fuel mixture, which is the mixture of the flow-through air and the flow-through fuel, to a value close to the theoretical air fuel ratio.

By controlling the fuel injection timing in such a way that the time over which the fuel injection timing and the valve overlap period overlap each other becomes longer and increasing the fuel injection quantity, it is possible to increase the flow-through fuel quantity while suppressing an increase in the quantity of fuel used in combustion in the cylinder 2. On the other hand, by controlling the fuel injection timing in such a way that the time over which the fuel injection timing and the valve overlap period overlap each other becomes shorter and decreasing the fuel injection quantity, it is possible to decrease the flow-through fuel quantity while suppressing a decrease in the quantity of fuel used in combustion in the cylinder 2. In this way, it is possible to adjust the flow-through fuel quantity by controlling the fuel injection timing and the fuel injection quantity. Thus, it is possible to adjust the air fuel ratio of the flow-through air-fuel mixture to a value close to the theoretical air fuel ratio by controlling the fuel injection timing and the fuel injection quantity.

As described above, when flow-through of fuel occurs, the energy of the exhaust gas increases by combustion of the flow-through fuel. The energy of the exhaust gas becomes maximum when the air fuel ratio of the flow-through air-fuel mixture is equal to the theoretical air fuel ratio.

Therefore, while the supercharging pressure is increased by the turbocharger 14, it is possible to increase the supercharging pressure more rapidly while suppressing the unpreferable exhaust emission more preferably, by adjusting not only the air fuel ratio of the exhaust gas but also the air fuel ratio of the flow-through air-fuel mixture to a value near the theoretical air fuel ratio as described above.

In the process of this embodiment, fuel injection through the fuel injection valve 3 may be effected multiple times. More specifically, fuel injection may be effected separately as injection during the valve overlap period Tov and injection after completion of valve overlap period Tov. In this case, the injection effected during the valve overlap period Tov can cause flow-through of fuel, and fuel used in combustion in the cylinder 2 can be provided by the injection effected after completion of the valve overlap period Tov.

In this embodiment also, the air fuel ratio of the exhaust gas may be adjusted to a lean air fuel ratio or a slightly rich air fuel ratio, as with the first embodiment. Third Embodiment

The basic structure of the internal combustion engine according to this third embodiment and its air-intake and exhaust systems is the same as that shown in FIG. 1, and a description thereof will be omitted.

### Process for Controlling Fuel Injection Timing While Supercharging Pressure is Increased

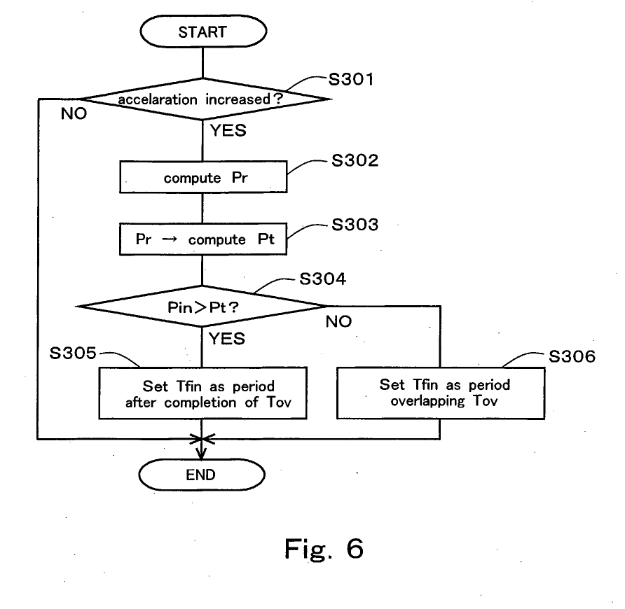

Here, a process for controlling the fuel injection timing while the supercharging pressure is increased by the turbocharger 14 according to this embodiment will be described with reference to FIG. 6. FIG. 6 is a flow chart of a control routine for controlling the fuel injection timing while the supercharging pressure is increased according to this embodiment. This routine is stored in the ECU 20 in advance, and executed repeatedly at regular intervals while the internal combustion engine 1 is running.

In this routine, firstly in step S301, a determination is made by the ECU 20 as to whether or not the accelerator position has been changed in the direction for increasing the acceleration based on the detection value of the accelerator position sensor 21. If the question in step S301 is answered in the affirmative, it is considered that the supercharging pressure is increased by the turbocharger 14, and the process of the ECU 20 proceeds to step S302. On the other hand, if the question in step S301 is answered in the negative, it is considered that the supercharging pressure is not increased, and the ECU 20 once terminates execution of this routine.

In step S302, the ECU computes a required supercharging pressure Pr that is demanded based on the accelerator position. The required supercharging pressure Pr is the pressure at which the engine load of the internal combustion engine 1 can be increased to a required engine load. The relationship between the required supercharging pressure Pr and the accelerator position is determined in advance by, for example, experiments.

Then, the process of the ECU 20 proceeds to step S303, where the ECU 20 computes a specified supercharging pressure Pt based on the required supercharging pressure Pr. The specified supercharging pressure Pt is such a pressure that if the supercharging pressure rises to the specified supercharging pressure Pt, it can be considered that the supercharging pressure will rise to the required supercharging pressure Pt rapidly even without combustion of fuel in the exhaust passage 13. The relationship between the required supercharging pressure Pr and the specified supercharging pressure Pt is determined in advance by, for example, experiments.

Then, the process of the ECU 20 proceeds to step S304, where a determination is made as to whether or not the intake pressure Pin detected by the intake pressure sensor 24 is higher than the specified supercharging pressure Pt. If the question in step S304 is answered in the affirmative, it is considered that the supercharging pressure has already exceeded the specified supercharging pressure Pt, and the process of the ECU 20 proceeds to step S305. On the other hand, if the question in step S304 is answered in the negative, it is considered that the supercharging pressure has not reached the specified supercharging pressure Pt, and the process of the ECU 20 proceeds to step S306.

In step S305, the ECU 20 sets the fuel injection timing Tfin as timing after the valve overlap period Tov has ended as shown in FIG. 2, in other words, the fuel injection timing Tfin is set in the time during which flow-through of fuel does not occur. Thereafter, the ECU 20 once terminates execution of this routine.

On the other hand, in step S306, the ECU 20 sets the fuel injection timing Tfin as timing that partly overlaps the valve overlap period Tov, in other words, the fuel injection timing Tfin is set in the time during which flow-through of fuel occurs. Thereafter, the ECU 20 once terminates execution of this routine.

According to the above described control routine, when the supercharging pressure is increased by the turbocharger 14, flow-through of fuel is allowed to occur until the supercharging pressure reaches the specified supercharging pressure Pt as is the case with the above described second embodiment, and flow-through of fuel is prohibited after the supercharging pressure has reached the specified supercharging pressure Pt as is the case with the above described first embodiment.

As per the above, according to this embodiment, when it can be considered, in increasing the supercharging pressure, that the supercharging pressure has risen sufficiently (namely when it can be considered that the supercharging pressure will rise to the required supercharging pressure Pr rapidly even without burning fuel in the exhaust passage 13), flow-through of fuel is prevented from occurring, even if the supercharging pressure has not reached the required supercharging pressure Pr. By this feature, it is possible to reduce the quantity of fuel used for increasing the energy of the exhaust gas. Thus, it is possible to increase the supercharging pressure more rapidly while preventing a decrease in gas mileage.

Although in the case of the above-described first to third embodiments, the fuel injection valve 3 is adapted to inject fuel directly into the combustion chamber 5 in the cylinder 2, the present invention can also be applied to the case where the fuel injection valve 3 is provided in the intake port 6 and adapted to inject fuel into the intake port 6.

In the latter case, if the timing of fuel injection through the fuel injection valve 3 is set as timing during the intake stroke after the valve overlap period has ended, flow-though of fuel will not occur as is the case with the first embodiment. On the other hand, if the timing of fuel injection through the fuel injection valve 3 is set as timing during the exhaust stroke or set to overlap the valve overlap period, flow-through of fuel will occur as is the case with the second embodiment.

In the case where flow-through of fuel is allowed to occur, the quantity of the flow-through fuel can be increased by increasing the quantity of fuel injection during the exhaust stroke or by lengthening the time over which the fuel injection timing and the valve overlap period overlap each other. On the other hand, the quantity of the flow-through fuel can be decreased by decreasing the quantity of fuel injection during the exhaust stroke or by shortening the time over which the fuel injection timing and the valve overlap period overlap each other.

The present invention may also be applied to the case where both a fuel injection valve adapted to inject fuel directly into the combustion chamber 5 in the cylinder 2 and a fuel injection valve adapted to inject fuel into the intake port 6 are provided. The present invention can also be applied to a diesel engine.

While the invention has been described in terms of preferred embodiments, those skilled in the art will recognize that the invention can be practiced with modifications within the spirit and scope of the appended claims.

### INDUSTRIAL APPLICABILITY

According to the control system for an internal combustion engine according to the present invention, it is possible to suppress the unpreferable exhaust emission while the supercharging pressure is increased more preferably.

1. A control system for an internal combustion engine comprising:
a supercharger that supercharges intake air using the energy of the exhaust gas;
an exhaust gas purification catalyst that purifies the exhaust gas provided in an exhaust passage;
overlap control means for controlling a valve overlap period defined as a period during which both an intake valve and an exhaust valve are open,
wherein while the supercharging pressure is increased by said supercharger, said valve overlap period is controlled by said valve overlap control means to regulate the quantity of flow-through air that flows from an intake port out into an exhaust port during the valve overlap period, whereby the air fuel ratio of the exhaust gas is adjusted to a target air fuel ratio.

2. A control system for an internal combustion engine according to claim 1, wherein said exhaust gas purification catalyst is a three way catalyst, and the value of said target air fuel ratio is equal to the theoretical air fuel ratio or close to the theoretical air fuel ratio.

3. A control system for an internal combustion engine according to claim 1, wherein the value of said target air fuel ratio is a lean air fuel ratio or a slightly rich air fuel ratio.

4. A control system for an internal combustion engine according to any one of claims 1 to 3, further comprising:
a fuel injection valve that injects fuel into said intake port or into a cylinder;
fuel injection timing control means for controlling the timing of fuel injection through said fuel injection valve; and
fuel injection quantity control means for controlling the quantity of fuel injection through said fuel injection valve,
wherein while the supercharging pressure is increased by said supercharger, the timing of fuel injection through said fuel injection valve is controlled by said fuel injection timing control means, and the quantity of fuel injection through said fuel injection valve is controlled by said fuel injection quantity control means, whereby at least a part of the fuel injected is caused to flow out into said exhaust port with said flow-through air, and the ratio of the quantity of the flow-through air and the quantity of the fuel that flows out into the exhaust port with the flow-through air is adjusted to the theoretical air fuel ratio or a value closed to the theoretical air fuel ratio.

5. A control system for an internal combustion engine according to claim 4, wherein when the supercharging pressure is increased by said supercharger, at least a part of the fuel injected through said fuel injection valve is caused to flow out into said exhaust port with said flow-through air only until the supercharging pressure reaches a specified supercharging pressure that is lower than a required supercharging pressure that is demanded, and after the supercharging pressure has reached said specified supercharging pressure the fuel injected through said fuel injection valve is prohibited from flowing out into said exhaust port with said flow-through air.
